(19) United States
(12) Patent Application Publication
(10) Pub. No.: US 2017/0308294 A1
(43) Pub. Date: Oct. 26, 2017

(54) TOUCH SENSITIVE MEMBER WITH FIRST AND SECOND ACTIVE REGIONS

(71) Applicant: HEWLETT-PACKARD DEVELOPMENT COMPANY, L.P., HOUSTON, TX (US)

(72) Inventors: GREGORY DOYLE CREAGER, BOISE, ID (US); ANDRE T. KEYS, BOISE, ID (US); SHAUN HENRY, BOISE, ID (US)

(21) Appl. No.: 15/510,024

(22) PCT Filed: Nov. 25, 2014
(86) PCT No.: PCT/US2014/067456

§ 371 Date: Mar. 9, 2017

(51) Int. Cl. G06F 3/0488; G06F 3/0484

(52) U.S. Cl. CPC G06F 3/04886; G06F 3/04847; G06F 2203/04803

(57) ABSTRACT

An example machine-readable non-transitory storage medium includes instructions executable by a processor of an electronic device to receive an input on a touch sensitive member of an electronic device, determine whether the input is within a first active region of the touch sensitive member or a second active region of the touch sensitive member, map the input to a first target when the input is determined to be within the first active region, send the mapped first input to an operating system of the electronic device, map the input to a second target when the input is determined to be within the second active region, and send the mapped second input to the operating system of the electronic device.

### BACKGROUND

End users appreciate performance and features in their electronic devices. They also appreciate ease of use and cost effective solutions for their electronic device needs. Designers and manufacturers may, therefore, endeavor to create and provide electronic devices directed toward at least some of these objectives.

### BRIEF DESCRIPTION OF THE DRAWINGS

The following detailed description references the drawings, wherein:

FIG. 1 is an example of an apparatus to use in an electronic device.

FIG. 2 is an example of adjustment of a first boundary of a first active region of the apparatus of FIG. 1.

FIG. 3 is an example of adjustment of a second boundary of a second active region of the apparatus of FIG. 1.

FIG. 4 is an example of simultaneous adjustment of a second boundary of a first active region and a first boundary of a second active region of the apparatus of FIG. 1.

FIG. 5 is an example of the addition of an anchor button to the apparatus of FIG. 1.

FIG. 6 is an example of adjustment of a location of a first active region of the apparatus of FIG. 5.

FIG. 7 is an example of adjustment of a first boundary of a first active region of the apparatus of FIG. 5.

FIG. 8 is an example of adjustment of a location of a second active region of the apparatus of FIG. 5.

FIG. 9 is an example of adjustment of a second boundary of a second active region of the apparatus of FIG. 5.

FIG. 10 is an example of the addition of a slider to the apparatus of FIG. 1.

FIG. 11 is an example of the addition of a control engine to the apparatus of FIG. 1.

FIG. 12 is an example of a machine-readable non-transitory storage medium including instructions executable by a processor of an electronic device.

FIG. 13 is an example of additional instructions on the machine-readable non-transitory storage medium of FIG. 12 that are executable by a processor of an electronic device.

FIG. 14 is an example of other additional instructions on the machine-readable non-transitory storage medium of FIG. 12 that are executable by a processor of an electronic device.

FIG. 15 is an example of further additional instructions on the machine-readable non-transitory storage medium of FIG. 12 that are executable by a processor of an electronic device.

FIG. 16 is an example of a method to use in an electronic device having a touch sensitive member.

FIG. 17 is an example of additional elements of the method to use in an electronic device having a touch sensitive member of FIG. 16.

FIG. 18 is an example of other additional elements of the method to use in an electronic device having a touch sensitive member of FIG. 17.

FIG. 19 is an example of further elements of the method to use in an electronic device having a touch sensitive member of FIG. 16.

### DETAILED DESCRIPTION

An electronic device may include a touch sensitive member that can, for example, translate movement of a user's finger or fingers into movement of a pointer or cursor on a screen associated with the electronic device. The touch sensitive member can also, for example, translate tapping of a user's finger or fingers as selection of an object or item on a screen associated with the electronic device. Once selected, the object or item on the screen may be manipulated by the user, such as, for example, moving its location of the screen, changing its size, editing it, etc. The touch sensitive member can be integrated into the electronic device or coupled to it as a peripheral via a wired or wireless connection.

The touch sensitive member may include an active region that is responsive to user touch to covert the touch into an input, for example, to an electronic device, as described above. This active region may be repositionable within the touch sensitive member. The size of this active region may also be adjustable. The use of this active region, however, may be limiting to at least some users because, for example, it doesn't allow multiple targets (e.g., desktop, region of a desktop, or an application) to be interacted with unless a user first switches between them. This may be perceived as an inconvenience and/or time consuming task by some users. It may also increase the chance of error associated with use of such a single active region if a user fails to correctly switch between such multiple targets.

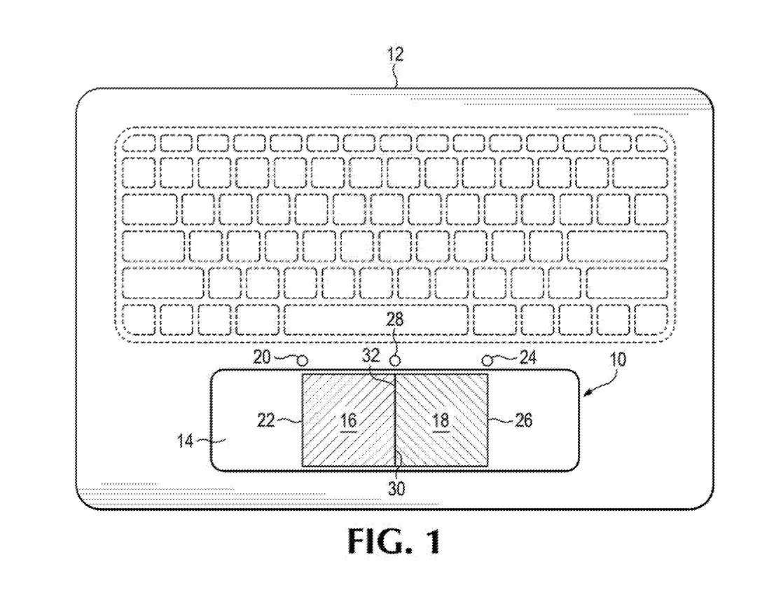

Examples directed to addressing the technical challenges associated with utilization of a single active region of a touch sensitive member are shown in FIGS. 1-19. These examples help to address these technical challenges by utilizing a first active region and a second active region on a touch sensitive member, as discussed more fully below.

An used herein, the term “electronic device” represents, but is not necessarily limited to, a printing device, tablet, phone, personal digital assistant, imaging device, wearable device, portable computer, desktop computer, keyboard, display, monitor, or combination thereof. As used herein, the term “circuitry” represents, but is not necessarily limited to, an interconnection of elements such as, for example, a resistor, inductor, capacitor, voltage source, current source, transistor, application specific integrated circuit (ASIC), gate array, processor, controller, switch, transformer, timer, relay, multiplexor, connector, comparator, amplifier, filter, and/or module having these elements that allow operations to be performed alone or in combination with other elements or components.

As used herein, the term “processor” represents, but is not necessarily limited to, an instruction execution system such as a computer-based system, an Application Specific Integrated Circuit (ASIC), a computing device, a hardware and/or machine-readable instruction system, or any combination thereof, that can fetch or obtain the logic from a machine-readable non-transitory storage medium and execute the instructions contained thereon. “Processor” can also include, for example, any controller, state-machine, microprocessor, logic control circuitry, cloud-based utility, service or feature, any other analogue, digital and/or mechanical implementation thereof, or any combination of the forgoing. A processor may be a component of a distributed system.

As used herein, the term “distributed system” represents, but is not necessarily limited to, multiple processors and machine-readable non-transitory storage media in different locations or systems that communicate via a network, as the cloud. As used herein, the term “cloud” represents, but is not necessarily limited to, computing resources (hardware and/or machine readable instructions) that are delivered as a service over a network (such as the internet). As used herein, the terms “include”, “includes”, “including”, “have”, “has”, “having” and variations thereof, mean the same as the terms “comprise”, “comprises”, and “comprising” or appropriate variations thereof.

As used herein, the term “machine-readable non-transitory storage medium” represents, but is not necessarily limited to, any medium that can contain, store, retain, or maintain programs, code, scripts, information, and/or data. A machine-readable non-transitory storage medium may include any one of many physical media such as, for example, electronic, magnetic, optical, electromagnetic, or semiconductor media. A machine-readable non-transitory storage medium may be a component of a distributed system. More specific examples of suitable machine-readable non-transitory storage media include, but are not limited to, a magnetic computer diskette such as floppy diskettes or hard drives, magnetic tape, a read-only memory (ROM), an erasable programmable read-only memory (EPROM), a flash drive or memory, a compact disc (CD), a digital video disk (DVD), or a memristor.

As used herein, the term “coupled” represents, but is not necessarily limited to, any suitable direct and/or indirect connection. For example, if a first component is described as being coupled to a second component, that coupling may be: (1) through a direct electrical and/or mechanical connection, (2) through an indirect electrical and/or mechanical connection via other devices and connections, (3) through an optical electrical connection, (4) through a wireless electrical connection (5) through an information association in machine readable instructions, an ASIC, or other processing component and/or (6) another satiable connection.

As used herein, the term “user profile” represents, but is not necessarily limited to, a set of default user settings for an electronic device. As used herein, the term “desktop” represent, but is not necessarily limited to, a region on a screen where icons, applications, control panels, etc. can be interacted with by a user of an electronic device.

An example of an apparatus 10 to use in an electronic device 12 is shown in FIG. 1. As can be seen in FIG. 1, apparatus 10 includes a touch sensitive member 14, a first active region 16 on touch sensitive member 14 to sense user touch and covert the touch into a first input to electronic device 12 and a second active region 18 on touch sensitive member 14 to sense user touch and convert the touch into a second input to electronic device 12. As can also be seen in FIG. 1, apparatus 10 includes a first anchor 20 adjacent a first boundary 22 of first active region 16 to adjust first boundary 22 of first active region 16 and a second anchor 24 adjacent a second boundary 26 of second active region 18 to adjust second boundary 26 of second active region 18. As can additionally be seen in FIG. 1, apparatus 10 also includes a third anchor 28 adjacent second boundary 30 of first active region 16 and first boundary 32 of second active region 18 to simultaneously adjust second boundary 30 of first active region 16 and first boundary 32 of second active region 18.

Touch sensitive member 14 may include, for example, a touchpad with first active region 16, second active region 18, first anchor 20, second anchor 24 and third anchor 28 being implemented in hardware. Alternatively, for example, touch sensitive member 14 may include a touch sensitive liquid crystal display (LCD) screen with first active region 16, second active region 18, first anchor 20, second anchor 24 and third anchor 28 being projected and moveable on the LCD screen. The locations of first active region 16 and second active region 18 on touch sensitive member 14 may be stored on a machine-readable non-transitory storage medium (not shown in FIG. 1) as configuration information that may be used by a processor (also not shown in FIG. 1) of electronic device 12 to determine the positions of respective first and second active regions 16 and 18 on touch sensitive member. For example, an INI format file may be created and stored on the machine-readable non-transitory storage medium that provides the locations of the corners of first active region 16 and locations of the corners second active region 18 as Cartesian coordinates. These coordinates may be updated as the positions of boundaries 22, 26, 30 and/or 32 are changed by anchors 20, 24 and/or 28.

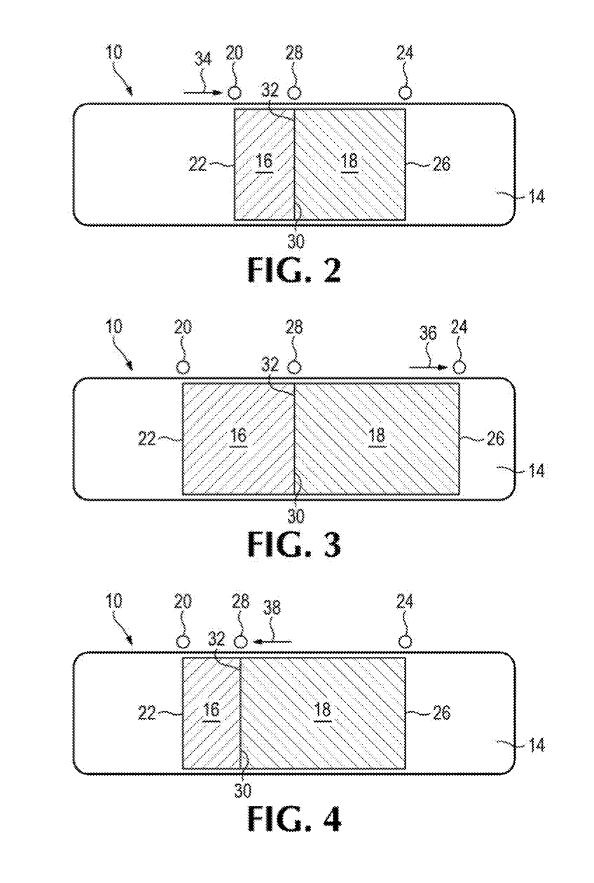

An example of adjustment of first boundary 22 of first active region 16 is shown in FIG. 2. As can be seen in FIG. 2, first boundary 22 of first active region 16 may be moved in the direction of arrow 34 via actuation of first anchor 20 to reduce the size of first active region 16 from the size shown in FIG. 1. Alternatively, the size of first active region 16 may be increased from the size shown in FIG. 1 by moving first boundary 22 in a direction opposite arrow 34 via actuation of first anchor 20.

An example of adjustment of second boundary 26 of second active region 18 is shown in FIG. 3. As can be seen in FIG. 3, second boundary 26 of second active region 18 may be moved in the direction of arrow 36 via actuation of second anchor 24 to increase the size of second active region 18 from the size shown in FIG. 1. Alternatively, the size of second active region 18 may be decreased from the size shown in FIG. 1 by moving second boundary 26 in a direction opposite arrow 36 via actuation of second anchor 24.

An example of simultaneous adjustment of second boundary 30 of first active region 16 and first boundary 32 of second active region 18 is shown in FIG. 4. As can be seen in FIG. 4, second boundary 30 of first active region 16 and first boundary 32 of second active region 18 may be simultaneously moved in the direction of arrow 38 via actuation of third anchor 28 to simultaneously decrease the size of first active region 16 and increase the size of second active region 18 from the sizes shown in FIG. 1. Alternatively, second boundary 30 of first active region 16 and first boundary 32 of second active region 18 may be simultaneously moved in a direction opposite arrow 38 via actuation of third anchor 28 to simultaneously increase the size of first active region 16 and decrease the size of second active region 18 from the sizes shown in FIG. 1.

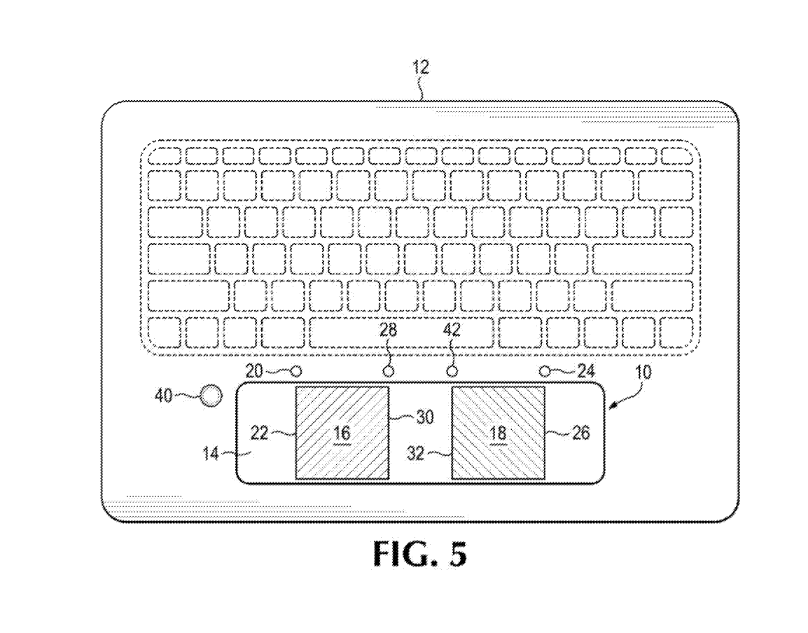

An example of the addition of an anchor button 40 to apparatus 10 to split first active region 16 from second active region 18 is shown in FIG. 5. As can be seen in FIG. 5, anchor button 40 also generates a fourth anchor 42 so that third anchor 28 is adjacent second boundary 30 of first active region 16 and fourth anchor 42 is adjacent first boundary 32 of second active region 18. This allows third anchor 28 to adjust second boundary 30 of first active region 16 and fourth anchor 42 to adjust first boundary 32 of second active region 18. Fourth anchor 42 may be implemented in hardware or, alternatively, projected on touch sensitive member 14 when touch sensitive member 14 includes a touch sensitive liquid crystal display (LCD) screen. Anchor button 40 includes any circuitry or combination of circuitry and executable instructions that split first active region 16 from second active region 18 and generates fourth anchor 42, as described above. For example, the circuitry may include a processor that executes instructions on a machine-readable non-transitory storage medium to split first active region 16 from second active region 18 and generate fourth anchor 42.

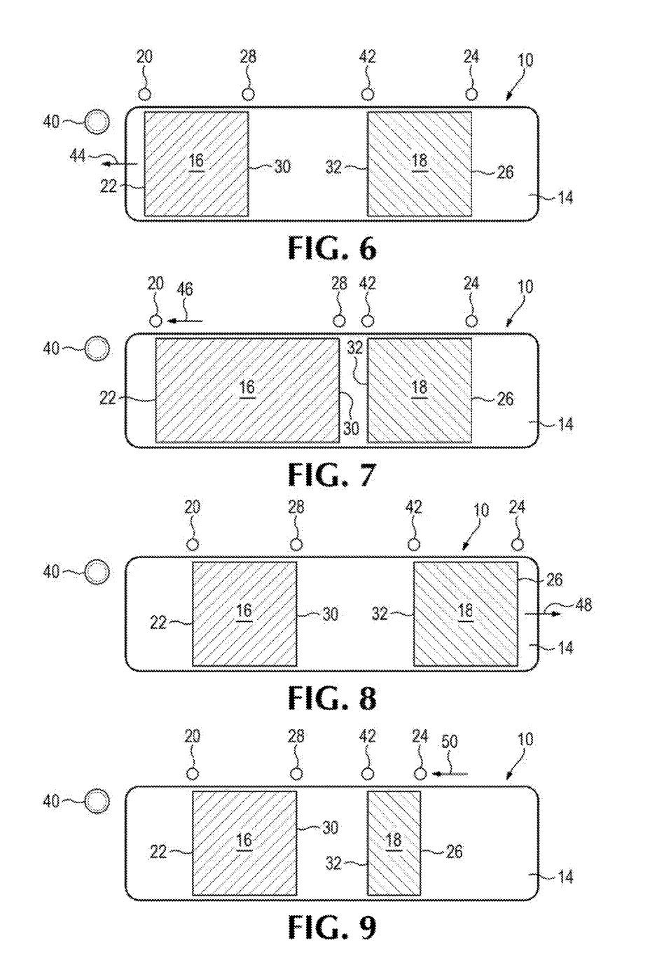

An example of adjustment of a location of first active region 16 is shown in FIG. 6. As can be seen in FIG. 6, first active region 16 may be moved in the direction of arrow 44 via actuation of first anchor 20 and third anchor 28 to change the location of first active region 16 on touch sensitive member 14 from the position shown in FIG. 5 to the position shown FIG. 6. Alternatively, first active region 16 may be moved in a direction opposite arrow 44 via actuation of first anchor 20 and third anchor 28 to change the location of first active region 16 on touch sensitive member from the position shown in FIG. 5.

An example of adjustment of first boundary 22 of first active region 16 is shown in FIG. 7. As can be seen in FIG. 7, first boundary 22 of first active region 16 may be moved in the direction of arrow 46 via actuation of first anchor 20 to increase the size of first active region 16 from the size shown in FIG. 5. Alternatively, the size of first active region 16 may be decreased from the size shown in FIG. 5, by movement of first boundary 22 of first active region 16 in a direction opposite arrow 46 via actuation of first anchor 20. Third anchor 28 may alternatively be used to decrease or increase the size of first active region 16 by actuating third anchor 28 to move second boundary 30 of first active region 16 in the direction of arrow 46 to decrease the size of first active region 16 or to move second boundary 30 in a direction opposite arrow 46 to increase the size of first active region 16.

An example of adjustment of a location of second active region 18 is shown in FIG. 8. As can be seen in FIG. 8, second active region 18 may be moved in the direction of arrow 48 via actuation of fourth anchor 42 and second anchor 24 to change the location of second active region 18 on touch sensitive member 14 from the position shown in FIG. 5 to the position shown in FIG. 8. Alternatively, second active region 18 may be moved in a direction opposite arrow 48 via actuation of fourth anchor 42 and second anchor 24 to change the location of second active region 18 on touch sensitive member from the position shown in FIG. 5.

An example of adjustment of second boundary 26 of second active region 18 is shown in FIG. 9. As can be seen in FIG. 9, second boundary 26 of second active region 18 may be moved in the direction of arrow 50 via actuation of second anchor 24 to decrease the size of second active region 18 from the size shown in FIG. 5. Alternatively, the size of second active region 18 may be increased from the size shown in FIG. 5. by movement of second boundary 26 of second active region 18 in a direction opposite arrow 50 via actuation of second anchor 24. Fourth anchor 42 may alternatively be used to increase or decrease the size of second active region 18 by actuating fourth anchor 42 to move first boundary 32 of second active region 18 in the direction of arrow 50 to increase the size of first active region 18 or to move first boundary 32 in a direction opposite arrow 50 to decrease the size of first active region 18.

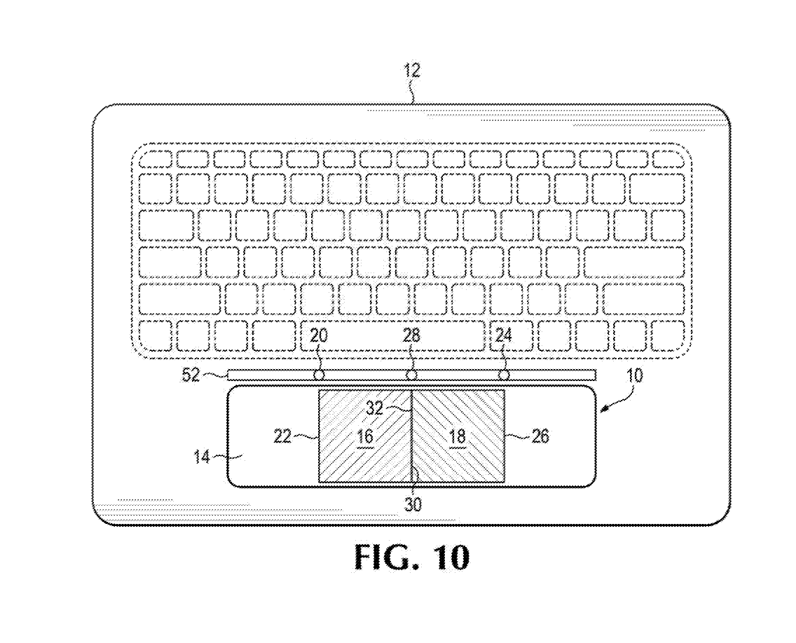

An example of the addition of slider 52 to apparatus 10 is shown in FIG. 10. As can be seen in FIG. 10, first anchor 20 is on slider 52 to adjust first boundary 22 of first active region 16, second anchor 24 is on slider 52 to adjust second boundary 26 of second active region 18, and third anchor 28 is on slider 52 to simultaneously adjust second boundary 30 of first active region 16 and first boundary 32 or second active region 18. Slider 52 helps separate first anchor 20, second anchor 24, and third anchor 28 from first active region 16 and second active region 18. This separation helps to prevent inadvertent changes to respective first, second, and third anchors 20, 24, and 28 during interaction with first active region 16 and second active region 18. Slider 52 may be implemented, for example, in hardware or, alternatively, protected on touch sensitive member 14 when touch sensitive member 14 includes a touch sensitive liquid crystal display (LCD) screen.

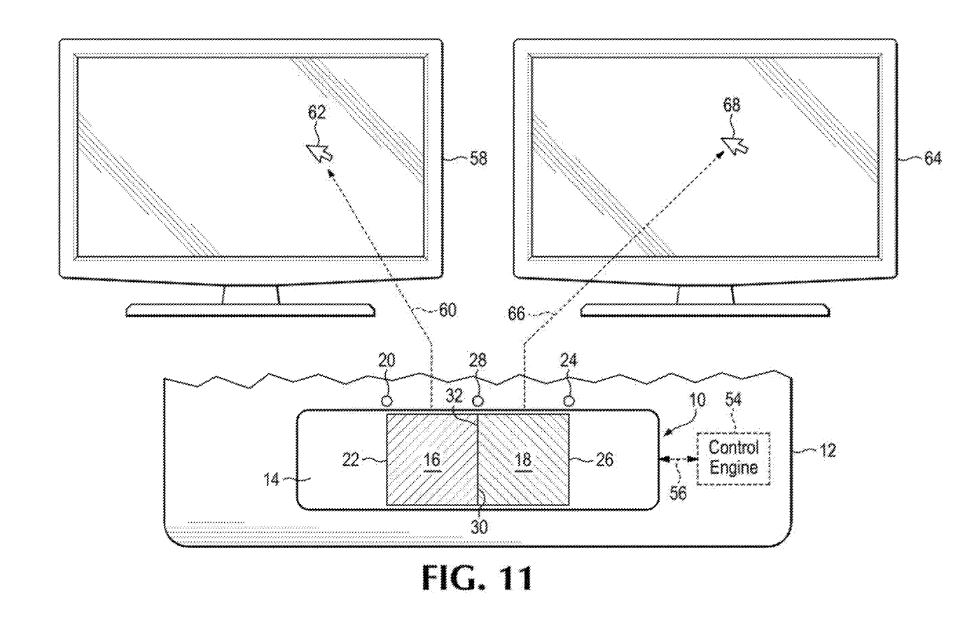

An example of the addition of a control engine 54 to apparatus 10 is shown in FIG. 11. As can be seen in FIG. 11, in this example, control engine 54 is inside electronic device 12 and is coupled to touch sensitive member 14, as indicated by double-headed arrow 56. Control engine 54 selects a first screen 58 to map to first active region 16, as indicated by arrow 60, so that the first input to electronic device 12 is displayed on first screen 58, as indicated, for example, by pointer 62. Control engine 54 also selects a second screen 64 to map to second active region 18, as indicated by arrow 66, so that the second input to electronic device 12 is displayed on second screen 64, as indicated, for example, by pointer 68.

Control engine 54, first active region 16, and second active region 18 allow apparatus 10 to interact with multiple targets by, for example, having one target on first screen 58 and a second target on second screen 64 without having to switch between these targets. Control engine 54 includes any circuitry or combination of circuitry and executable instructions that selects and maps first screen 58 to first active region 16 and second screen 64 to second active region 18, as described above. For example, the circuitry may include a processor that executes instructions on a machine-readable non-transitory storage medium to map first screen 58 to first active region 16 and second screen 64 to second active region 18.

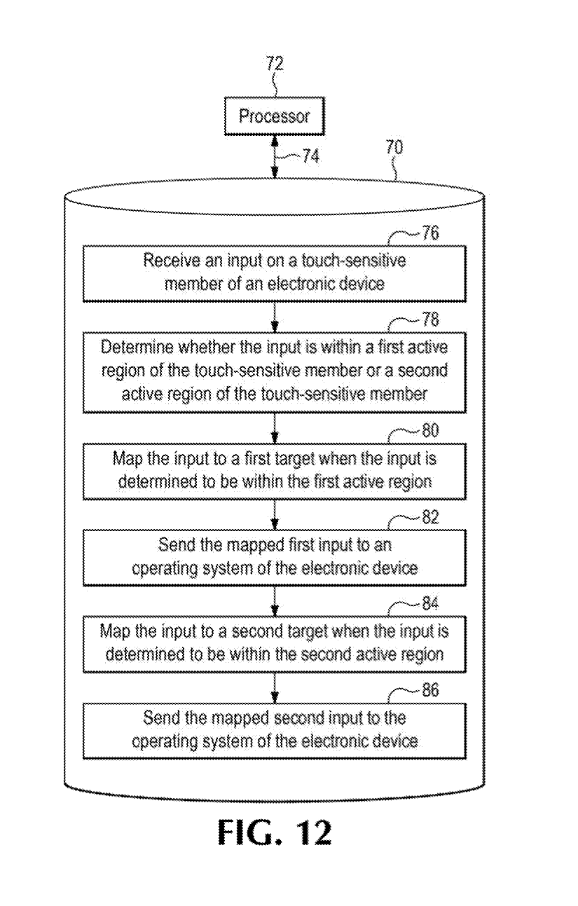

An example of a machine-readable non-transitory storage medium 70 including instructions executable by a processor 72, as indicated by double-headed arrow 74, of an electronic device is shown in FIG. 12. As can be seen in FIG. 12, machine-readable non-transitory storage medium 70 includes instructions 76 executable by processor 72 to receive an input on a touch sensitive member of an electronic device and instructions 78 executable by processor 72 to determine whether the input is within a first active region of the touch sensitive member or a second active region of the touch sensitive member. The touch sensitive member may include, for example, touch sensitive member 14 of apparatus 10 and the first and second active regions may include, for example, first active region 16 and second active region 18 of apparatus 10.

As can also be seen in FIG. 12, machine-readable non-transitory storage medium 70 includes additional instructions 80 executable by processor 72 to map the input to a first target when the input is determined to be within the first active region and instructions 82 executable by processor 72 to send the mapped first input to an operating system of the electronic device. As can additionally be seen in FIG. 12, machine-readable non-transitory storage medium 70 includes further instructions 84 executable by processor 72 to map the input to a second target when the input is determined to be within the active region and instructions 86 executable by processor 72 to send the mapped second input to the operating system of the electronic device. The first target may include, for example, a first screen, a first desktop, a portion of the first desktop or a first application. Similarly, the second target may include, for example, a second screen, a second desktop, a portion of the second desktop or a second application.

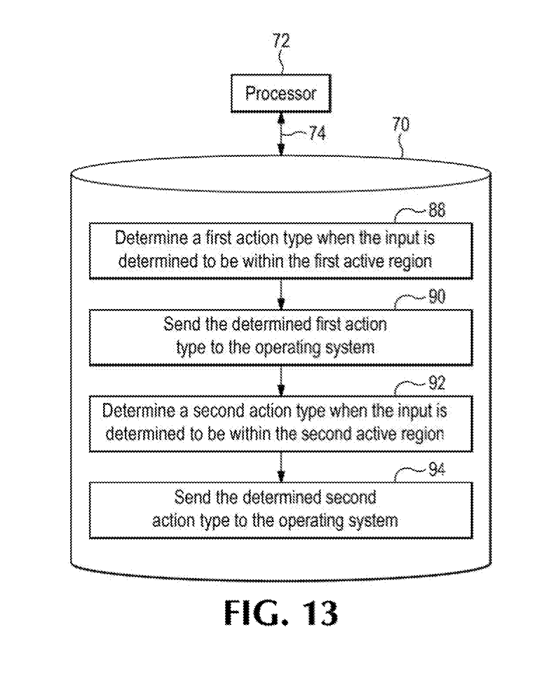

An example of additional instructions on machine-readable non-transitory storage medium 70 that are executable by processor 72 of an electronic device are shown in FIG. 13. As can be seen in FIG. 13, machine-readable non-transitory storage medium 70 may include instructions 88 executable by processor 72 to determine a first action type (e.g., a user pointing, clicking, selection, etc.) when the input is determined to be within the first active region and instructions 90 executable by processor 72 to send the determined first action type to the operating system of the electronic device. As can also be seen in FIG. 13, machine-readable non-transitory storage medium 70 may include instructions 92 executable by processor 72 to determine a second action type (e.g., a user pointing, clicking, selection, etc.) when the input is determined to be within the second active region and instructions 94 executable by processor 72 to send the determined second action type to the operating system of the electronic device.

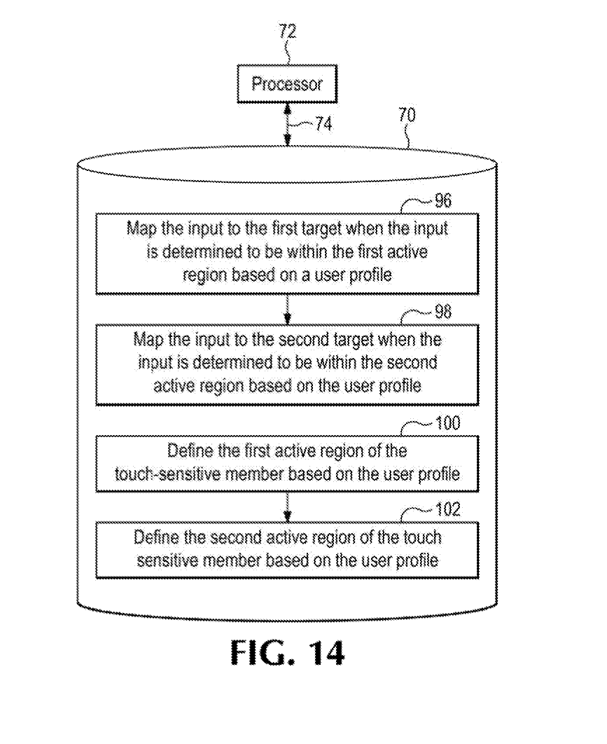

An example of other additional instructions on machine-readable non-transitory storage medium 70 that are executable by processor 72 of an electronic device are shown in FIG. 14. As can be seen in FIG. 14, machine-readable non-transitory storage medium 70 may include instructions 96 executable by processor 72 to map the input to the first target when the input is determined to be within the first active region based on a user profile and instructions 98 executable by processor 72 to map the input to the second target when the input is determined to be within the second active region based on the user profile. In such cases, machine-readable non-transitory storage medium 70 may include additional instructions 100 executable by processor 72 to also define the first active region (e.g., size, location, functionality, etc.) of the touch sensitive member based on the user profile and instructions 102 executable by processor 72 to also define the second active region (e.g., size, location, functionality, etc.) of the touch sensitive member based on the user profile.

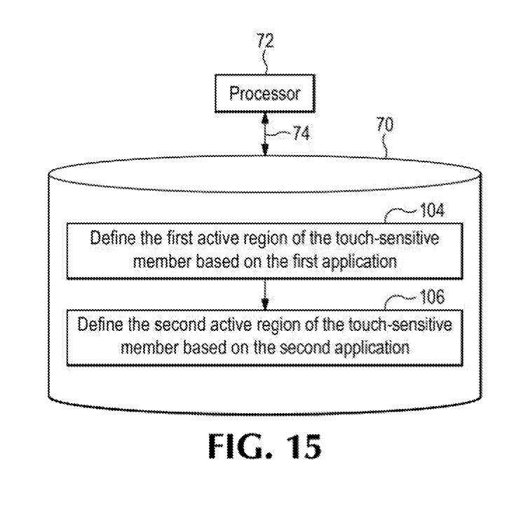

An example of further additional instructions on machine-readable non-transitory storage medium 70 that are executable by processor 72 of an electronic device are shown in FIG. 15. In this example, the first target includes a first application and the second target includes a second application. In such a case, machine-readable non-transitory storage medium 70 may include instructions 104 that are executable by processor 72 to define the first active region (e.g., size, location, functionality, etc.) of the touch sensitive member based on the first application and instructions 106 to define the second active region (e.g., size, location, functionality, etc.) of the touch sensitive member based on the second application.

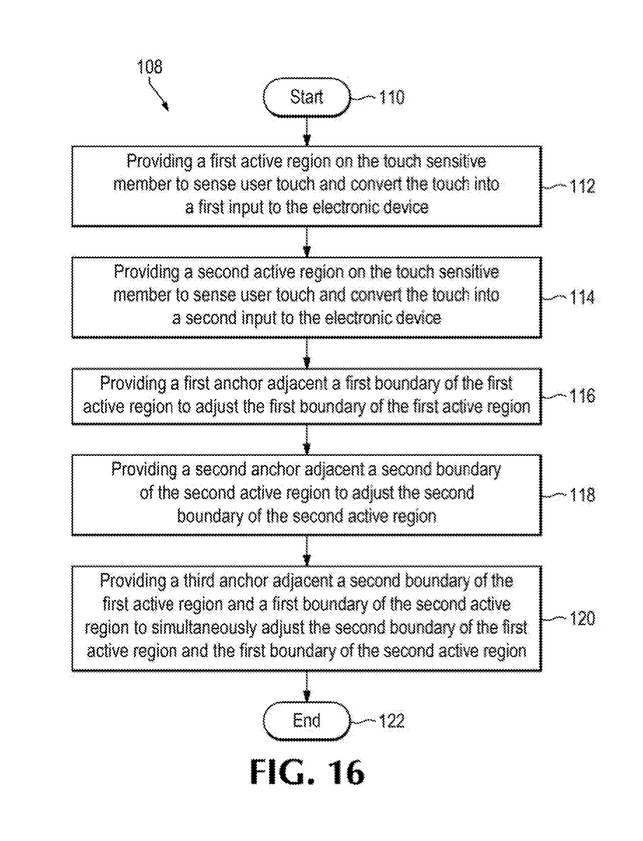

An example of a method 108 to use in an electronic device having a touch sensitive member is shown in FIG. 16. As can be seen in FIG. 16, method 108 starts 110 by providing a first active region on the touch sensitive member to sense user touch and convert the touch into a first input to the electronic device, as indicated by block 112, and providing a second active region on the touch sensitive member to sense user touch and convert the touch into a second input to the electronic device, as indicated by block 114. The touch sensitive member may include, for example, touch sensitive member 14 of apparatus 10 and the first and second active regions may include, for example, first active region 16 and second active region 18 of apparatus 10.

As can also be seen in FIG. 16, method 108 additionally includes providing a first anchor adjacent a first boundary of the first active region to adjust the first boundary of the first active- region, as indicated by block 116, providing a second anchor adjacent a second boundary of the second active region to adjust the second boundary of the second active region, as indicated by block 118, and providing a third anchor adjacent a second boundary of the first active region and a first boundary of the second active region to simultaneously adjust the second boundary of the first active region and the first boundary of the second active region, as indicated by block 120. Method 108 may then end 122. The first anchor, second anchor, and third anchor may include, for example, first anchor 20, second anchor 24, and third anchor 28 of apparatus 10.

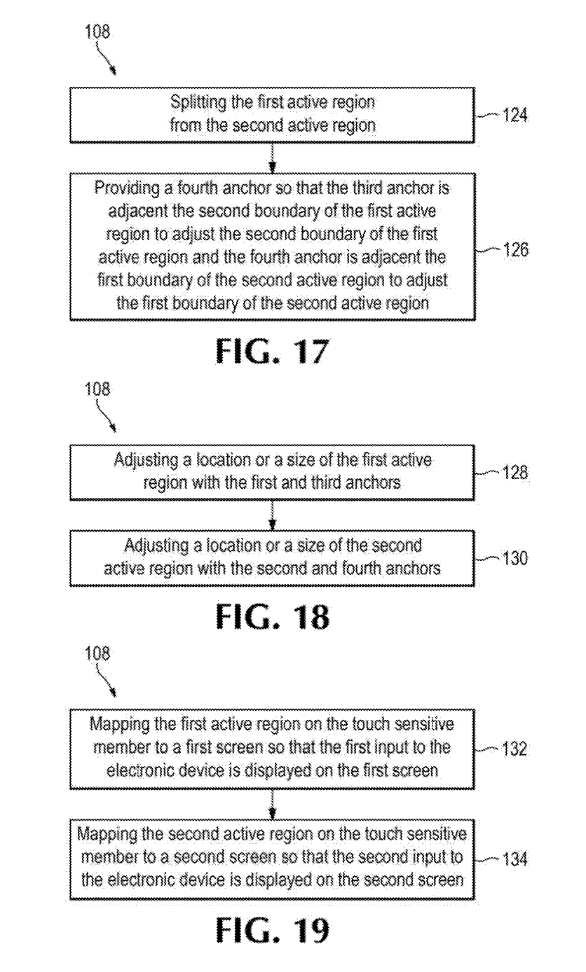

An example of additional elements of method 108 is shown in FIG. 17. As can be seen in FIG. 17, method 108 may include splitting the first active region from the second active region, as indicated by block 124, and providing a fourth anchor so that the third anchor is adjacent the second boundary of the first active region to adjust the second boundary of the first active region and the fourth anchor is adjacent the first boundary of the second active region to adjust the first boundary of the second active region, as indicated by block 126. The fourth anchor may include, for example, fourth anchor 42 of apparatus 10.

An example of other additional elements of method 108 is shown in FIG. 18. The additional elements are based on method 108 including the elements of FIG. 17. As can be seen in FIG. 18, method 108 may include adjusting a location or a size of the first active region with the first and third anchors, as indicated by block 128, and adjusting a location or a size of the second active region with the second and fourth anchors, as indicated by block 130.

An example of further elements of the method 108 is shown in FIG. 19. As can be seen in FIG. 19, method 108 may include mapping the first active region on the touch sensitive member to a first screen, such as, for example, first screen 58, so that the first input to the electronic device is displayed on the first screen, as indicated by block 132. As can also be seen in FIG. 19, method 108 may include mapping the second active region on the touch sensitive member to a second screen, such as, for example, second screen 64, so that the second input to the electronic device is displayed on the second screen, as indicated by block 134.

Although several drawings have been described and illustrated in detail, it is to be understood that the same are intended by way of illustration and example. These examples are not intended to be exhaustive or to be limited to the precise form disclosed. Modifications and variations may well be apparent. For example, although two active regions 16 and 18 have be shown and described above, it is to be understood that other examples of an apparatus, method, and/or machine-readable non-transitory storage medium may utilize more than two active regions. As another example, although apparatus 10 has been illustrated and described as being integrated into electronic device 12, it is to be understood that in other examples, apparatus 10 may instead be coupled to an electronic device, such as electronic device 12, as a peripheral via a wired or wireless connection.

Additionally, reference to an element in the singular is not intended to mean one, unless explicitly so stated. Furthermore, method elements are not limited to the sequence or order described and illustrated. Moreover, no element or component is intended to be dedicated to the public regardless of whether the element or component is explicitly recited in the following claims.

What is claimed is:

1. An apparatus to use in an electronic device, comprising:
a touch sensitive member;
a first active region on the touch sensitive member to sense user touch and convert the touch into a first input to the electronic device;
a second active region on the touch sensitive member to sense user touch and convert the touch into a second input to the electronic device;
a first anchor adjacent a first boundary of the first active region to adjust the first boundary of the first active region;
a second anchor adjacent a second boundary of the second active region to adjust the second boundary of the second active region; and
a third anchor adjacent a second boundary of the first active region and a first boundary of the second active region to simultaneously adjust the second boundary of the first active region and the first boundary of the second active region.

2. The apparatus of claim 1, further comprising an anchor button to split the first active region from the second active region and to generate a fourth anchor so that the third anchor is adjacent the second boundary of the first active region to adjust the second boundary of the first active region and the fourth anchor is adjacent the first boundary of the second active region to adjust the first boundary of the second active region.

3. The apparatus of claim 2, wherein the first and third anchors adjust one of a location and a size of the first active region on the touch sensitive member and further wherein the second and fourth anchors adjust one of a location and a size of the second active region on the touch sensitive member.

4. The apparatus of claim 1, further comprising a slider, wherein the first anchor is on the slider to adjust the first boundary of the first active region, the second anchor is on the slider to adjust the second boundary of the second active region, and the third anchor is on the slider to simultaneously adjust the second boundary of the first active region and the first boundary of the second active region.

5. The apparatus of claim 1, further comprising a control engine to select a first screen to map to the first active region on the touch sensitive member so that the first input to the electronic device is displayed on the first screen and to select a second screen to map to the second active region on the touch sensitive member so that the second input to the electronic device is displayed on the second screen.

6. A machine-readable non-transitory storage medium comprising instructions executable by a processor of an electronic device to:
receive an input on a touch sensitive member of an electronic device;
determine whether the input is within one of a first active region of the touch sensitive member and a second active region of the touch sensitive member;
map the input to a first target when the input is determined to be within the first active region;
send the mapped first input to an operating system of the electronic device;
map the input to a second target when the input is determined to be within the second active region; and
send the mapped second input to the operating system of the electronic device.

7. The machine-readable non-transitory storage medium of claim 6, further comprising additional instructions executable by the processor of the electronic device to:
determine a first action type when the input is determined to be within the first active region;
send the determined first action type to the operating system;
determine a second action type when the input is determined to be within the second active region; and
send the determined second action type to the operating system.

8. The machine-readable non-transitory storage medium of claim 6, wherein the first target includes one of a first screen, a first desktop, a portion of the first desktop, and a first application, and further wherein the second target includes one of a second screen, a second desktop, a portion of the second desktop, and a second application.

9. The machine-readable non-transitory storage medium of claim 6, further comprising additional instructions executable by the processor to:
map the input to the first target when the input is determined to be within the first active region based on a user profile; and
map the input to the second target when the input is determined to be within the second active region based on the user profile.

10. The machine-readable non-transitory storage medium of claim 9, further comprising additional instructions executable by the processor to:
define the first active region of the touch sensitive member based on the user profile; and
define the second active region of the touch sensitive member based on the user profile.

11. The machine-readable non-transitory storage medium of claim 6, wherein the first target includes a first application and the second target includes a second application, and further comprising additional instructions executable by the processor to:
define the first active region of the touch sensitive member based on the first application; and
define the second active region of the touch sensitive member based on the second application.

12. A method to use in an electronic device having a touch sensitive member, comprising:
providing a first active region on the touch sensitive member to sense user touch and convert the touch into a first input to the electronic device;
providing a second active region on the touch sensitive member to sense user touch and convert the touch into a second input to the electronic device;
providing a first anchor adjacent a first boundary of the first active region to adjust the first boundary of the first active region;
providing a second anchor adjacent a second boundary of the second active region to adjust the second boundary of the second active region; and
providing a third anchor adjacent a second boundary of the first active region and a first boundary of the second active region to simultaneously adjust the second boundary of the first active region and the first boundary of the second active region.

13. The method of claim 12, further comprising:
splitting the first active region from the second active region; and
providing a fourth anchor so that the third anchor is adjacent the second boundary of the first active region to adjust the second boundary of the first active region and the fourth anchor is adjacent the first boundary of the second active region to adjust the first boundary of the second active region.

14. The method of claim 13, further comprising:
adjusting one of a location and a size of the first active region with the first and third anchors; and
adjusting one of a location and a size of the second active region with the second and fourth anchors.

15. The method of claim 12, further comprising:
mapping the first active region on the touch sensitive member to a first screen so that the first input to the electronic device is displayed on the first screen; and
mapping the second active region on the touch sensitive member to a second screen so that the second input to the electronic device is displayed on the second screen.
